(19) United States
(12) Patent Application Publication
(10) Pub. No.: US 2018/0084772 A1
(43) Pub. Date: Mar. 29, 2018

(54) SPECIALIZED TRAP FOR GROUND TRUTHING AN INSECT RECOGNITION SYSTEM

(71) Applicant: Verily Life Sciences LLC, South San Francisco, CA (US)

(72) Inventors: Eric Peeters, San Jose, CA (US); Timothy Prachar, Menlo Park, CA (US); Peter Massaro, Belmont, CA (US); Yi Han, San Francisco, CA (US); Nigel Snoad, Woodside, CA (US)

(21) Appl. No.: 15/697,600

(22) Filed: Sep. 7, 2017

Related U.S. Application Data
(60) Provisional application No. 62/398,885, filed on Sep. 23, 2016.

(51) Int. Cl. A01M 1/02; A01M 1/10; A01M 1/14

(52) U.S. Cl. CPC A01M 1/026; H04L 67/12; A01M 1/14; A01M 1/106

(57) ABSTRACT

Systems and methods can be provided to monitor insects (e.g., mosquitoes) in the field and gather data to ground truth one or more sensors or machine learning classification algorithms for classifying insects. A trap with various sensor capabilities can capture various insects and data pertaining to the captured insects. Some embodiments may enable offline identification of information by an entomologist or other individuals and use the identification information to ground-truth the one or more sensors. Using the trap with the various sensor capabilities increases the availability and diversity of training data for machine learning classification algorithms on the primary sensor.

### CROSS-REFERENCE TO RELATED APPLICATIONS

The present application is related to and claims the benefit of priority of U.S. Provisional Application No. 62/398,885, filed Sep. 23, 2016, entitled “SPECIALIZED TRAP FOR GROUND TRUTHING AN INSECT RECOGNITION SYSTEM”, the entirety of which is incorporated herein by reference.

### BACKGROUND

The present disclosure relates in general to sensors, and in particular to sensors for insect traps.

Conventional methods for accurately classifying an insect have been very labor intensive and inefficient, for example, by requiring an entomologist to visually inspect each insect as it is trapped by a trap.

### BRIEF SUMMARY

Various examples are described for systems and methods of ground truthing an insect recognition system. One disclosed system can include a roll of substrate material, the substrate material having upper and lower surfaces and an adhesive applied to at least one of the upper or lower surfaces; a motor coupled to the roll of substrate material and configured to rotate the roll of substrate material to dispense the substrate material into an insect trap; a sensor positioned along a dispensing path of the substrate material and configured to capture information associated with the surface of the dispensed substrate having the adhesive, the sensor further configured to output sensor signals based on the captured information; and a computing device including one or more processors, the computing device configured to receive the sensor signals from the sensor, to transmit at least a portion of the captured information to another computing device, to receive classifications of insects based on the captured information, and to train a machine-learning insect classifier based on the classifications.

Another disclosed system can include an insect trap enclosure defining a trap volume and having at least one opening to enable insects to enter the trap volume from an environment; a sensor positioned proximate to the insect trap configured to capture information about insects that enter the trap volume from the environment and to transmit sensor signals comprising the captured information; a computing device in communication with the sensor and configured to: receive the sensor signals; recognize, using an object recognition process, at least one insect based on the captured information; receive an indication of a type of insect based on the displayed captured information; and train the object recognition process based on the recognized insect and the indication of the type of insect.

One disclosed method can include capturing one or more insects; capturing a time associated with a capture of each of the one or more insects; capturing data associated with each of the one or more insects; transmitting the data and the times to a computing device; recognizing, using an object recognition process, one or more of the one or more captured insects; receiving, via user input, indications of insect types for one or more of the one or more captured insects; and training the object recognition process based on the indications of insect types and the recognized captured insects.

Another disclosed method can include dispensing a substrate into an insect trap, the substrate comprising upper and lower surfaces and an adhesive applied to at least one of the upper or lower surfaces; periodically applying marks to the substrate as it is dispensed, the marks indicating time periods; capturing, using the adhesive, one or more insects on the substrate; capturing data associated with the one or more captured insects and the marks; transmitting the captured data to a computing device; recognizing, using an object recognition process, one or more of the one or more captured insects; receiving, via user input, indications of insect types for one or more of the one or more captured insects; and training the object recognition process based on the indications of insect types and the recognized captured insects.

These illustrative examples are mentioned not to limit or define the scope of this disclosure, but rather to provide examples to aid understanding thereof. Illustrative examples are described in the Detailed Description, which provides further description. Advantages offered by various examples may be further understood by examining this disclosure.

### BRIEF DESCRIPTION OF THE DRAWINGS

FIG. 1 depicts a block diagram of an insect classification and training system in accordance with certain embodiments.

FIG. 2 illustrates a process of ground truthing an insect recognition system in accordance with certain embodiments.

FIG. 3 depicts a flow chart for ground truthing an insect recognition system in accordance with certain embodiments.

FIG. 4 depicts another flow chart for ground truthing an insect recognition system in accordance with certain embodiments.

FIG. 5 shows a block diagram of a computer apparatus according to certain embodiments.

### DETAILED DESCRIPTION

Some embodiments can provide a specialized trap for ground truthing an insect recognition system. Certain embodiments can capture individual insects where the individual insects may be identified by an entomologist at a later time. As a batch of insects are captured for identification at a later time, some embodiments may include a timestamp mechanism that facilitates the identification of a time associated with when each individual insect was captured.

Conventionally, an entomologist would be situated next to an insect sensor for an extended period of time and manually identifying the species each time an insect is trapped. In some instances, the entomologist may examine a distribution of individuals, species, or sex over a 24-hour or longer collection period (e.g., a week). When examining a distribution of insects over an extended period of time, the entomologist may be unable to identify the individual insects to which each sensor signal corresponds. To train an insect recognition algorithm, it would be necessary to have an accurate identification of an insect (e.g., performed by an entomologist) to be compared with a computer identification of the same insect using the insect recognition algorithm. As there have not been ways to distinguish when certain insects are caught, a person would need to be constantly manning the trap to observe the order in which the insects are trapped.

Some embodiments provide systems and methods for enabling the later identification of sensor signals associated with an insect in a batch of insects. Gathering additional data can facilitate the ground truthing of an insect classifier and increase classification accuracy. Certain embodiments can train the insect recognition system that classifies the insect species by using a machine learning algorithm on the insect attributes (e.g., wingbeat frequency) and by using the additional data.

Some embodiments provide a trap that enables a remote entomologist or multiple specialists to classify one or more insects by visually or physically identifying insects that are trapped. In some embodiments, the trap can capture individual insects separately so that an entomologist can batch identify the insects at a later time. In certain embodiments, the trap can be a rolling piece of sticky paper, e.g., flypaper, such that as insects fly into the trap and, over time, are trapped by the sticky paper, the respective positions of the insects on the sticky paper may correspond to a time of capture recorded by an automated sensor. In some embodiments, the sensor may have a set of revolving vials or containers that are each designed to capture and hold a single or small number of insects. The trap may contain preservatives to ensure that the insect samples are suitable for further analysis when collected.

Some embodiments can provide a trap that takes a set of high resolution images of each insect as it flies into the trap. The insects can be captured over time. One or more sensors (e.g., a camera) that are part of the insect recognition system can capture information (e.g., images) about the insects. The captured information can then be provided to a processing service that includes an entomologist. The entomologist can use these images to classify the insects at a later time. In certain embodiments, computer vision algorithms can be used to classify these insects.

In some embodiments, the specialized trap can be placed in remote locations where it may be inconvenient for a person or an entomologist to constantly monitor the insects captured. The insect species may be identified remotely and by any and multiple persons (e.g., one or more remote entomologists) who has access to the captured data. The specialized trap may also be placed at a location for a long period of time, thereby allowing the trap to capture a larger number of insects without requiring a person to gather up the specimens frequently. For instance, some embodiments may use extended rolls of sticky paper to capture insects over a longer period of time. The roll of sticky paper may continue to capture more insects so long as the roll of sticky paper has not run out. Certain embodiments may also rotate the roll of sticky paper at a variable rate such that a fixed amount of sticky paper may capture a larger number of insects and possibly over a longer period of time.

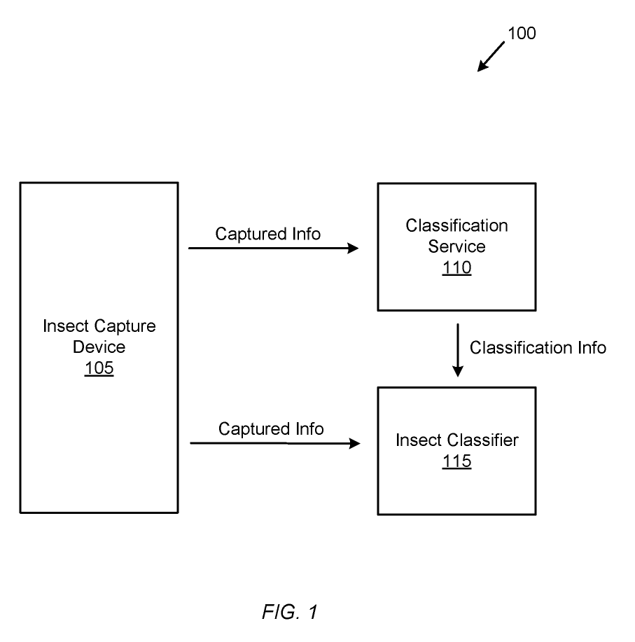

FIG. 1 depicts a block diagram of an automated insect classification and training system 100 in accordance with certain embodiments. As shown in FIG. 1, automated insect classification and training system 100 can include an insect capture device 105, a classification service 110, and an insect classifier 115. There may be more or fewer components to automated insect classification and training system 100 than those shown in FIG. 1. For example, some embodiments may include one or more wireless transmitters, data storage (e.g., database for storing insect information including characteristics or other data that can be used to identify insects), etc.

In some embodiments, insect capture device 105 can include a specialized trap that captures one or more insects such as mosquitoes. Insect capture device 105 can capture individual insects separately so that an entomologist can batch identify the insects at a later time. In certain embodiments, insect capture device 105 can include one or more sensors that can capture information pertaining to the captured insect, such as image information, video information, sound information, etc. In certain embodiments, insect capture device 105 can include additional components or fewer components. Some embodiments may further include a timestamp mechanism that enables the identification of a time at which each insect is captured.

In certain embodiments, insect capture device 105 can include a roll of substrate material and a motor. The roll of substrate material can have upper and lower surfaces and an adhesive applied to at least one of the upper or lower surfaces. For example, the roll of substrate material can be sticky paper. The motor can be coupled to the roll of substrate material and configured to rotate the roll of substrate material to dispense the substrate material onto a surface, e.g., a path defined by one or more rollers. As the roll of substrate material is dispensed onto a surface, the adhesive surface may be exposed such that insects that come into contact with the adhesive surface would be caught by the surface. Certain portion of the adhesive surface may be exposed during certain time periods. For example, the substrate may travel through a trap enclosure and capture insects while within the enclosure. Insects caught at certain portions of the adhesive surface can then be determined to be caught at those corresponding time periods.

Different embodiments of insect capture device 105 can capture one or more insects differently. For instance, in some embodiments, insect capture device 105 can include an insect trap enclosure that defines a trap volume and that has at least one opening for insects to enter the trap volume from an environment. In some embodiments, the trap enclosure can be a vial. In certain embodiments, the trap enclosure can be a large enclosure that has sticky tape or vessels/containers within the enclosure for trapping insects.

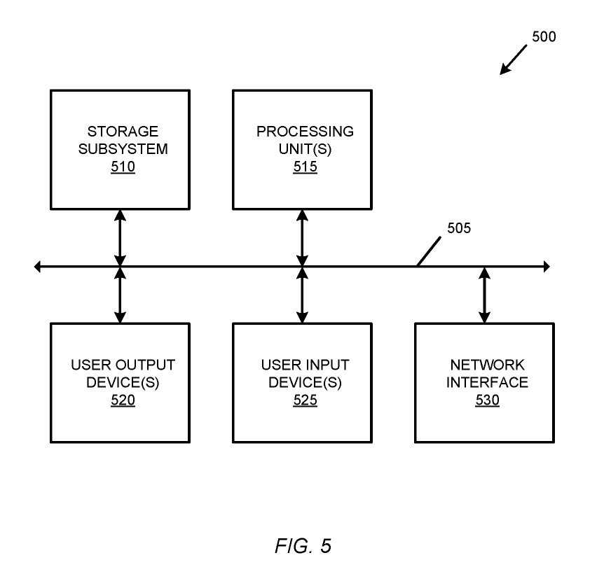

In some embodiments, insect capture device 105 can include a computing device, as may be seen in FIG. 5 and described below. In certain embodiments, the computing device can assemble capture information that includes information from the sensor signals and send the capture information to a classification service 110. The capture information that is sent to classification service 110 may further include time information or other information pertaining to the captured insects. In some embodiments, the computing device may display at least a portion of the captured information at a user interface (e.g., display screen) of the computing device.

In some embodiments, classification service 110 can be a service that identifies an insect and its species based on data pertaining to a captured insect. In certain embodiments, the service includes an entomologist or an individual who can identify the captured insect based on the data pertaining to the captured insect. The service may provide the data pertaining to the captured insect to the entomologist or individual(s). In some embodiments, the data provided to the entomologist or individual(s) may include image data, video data, sound data, weight data, conductivity data, etc. or a combination thereof. The entomologist or individual(s) may then identify the captured insect and provide classification information that includes information identifying the insect (e.g., species, genus, family, subfamily, etc.).

Classification service 110 may obtain classification information based on the data provided to the entomologist or the individual. The classification information may include “truthful information” on the type of insect that was captured. “Truthful information” may be identifying information that is accurate beyond a threshold degree (e.g., 99.9% accurate). In some embodiments, classification service 110 may provide the data to multiple individuals to obtain classification information. In certain embodiments, classification service 110 may be a local service including a computing device coupled to insect capture device 105. In some embodiments, classification service 110 can be a remote service where one or more computing devices communicate with insect capture device 105 via a network.

Insect classifier 115 can classify insects based on the data obtained from insect capture device 105 using an insect classification algorithm, which are discussed below. In some embodiments, insect classifier 115 can classify an insect based on the algorithm without any human input. In certain embodiments, insect classifier 115 has machine learning capability that can adjust its classification scheme based on inputs provided by classification service 110 (e.g., human experts). Insect classifier 115 can receive classification information from classification service 110 and can train the insect classification algorithm (also referred to as a machine-learning insect classifier) based on the classification information.

In some embodiments, insect classifier 115 can include a computing device that includes one or more processors and memory coupled to the one or more processors. In certain embodiments, the computing device may be coupled to insect capture device 105. The computing device can be configured to receive sensor signals from one or more sensors. Upon receiving the sensor signals, the computing device can recognize, using an object recognition process, at least one insect based on the captured information. Some instances of known object recognition algorithms may include the Huffman and Clowes line interpretation algorithm or the Generate and Test algorithm; however, any suitable object recognition algorithm may be employed.

In some embodiments, insect classifier 115 can train the object recognition process based on the recognized insect and the classification information received from classification service 110. As insect classifier 115 receives confirmation of a classification based on the information received from classification service 110, insect classifier 115 may adjust a weight of one or more factors used in deriving the classification results. For example, insect classifier 115 may increase the weight placed on classifying the insect based on a wingbeat frequency being above a threshold value or physical features of the insect.

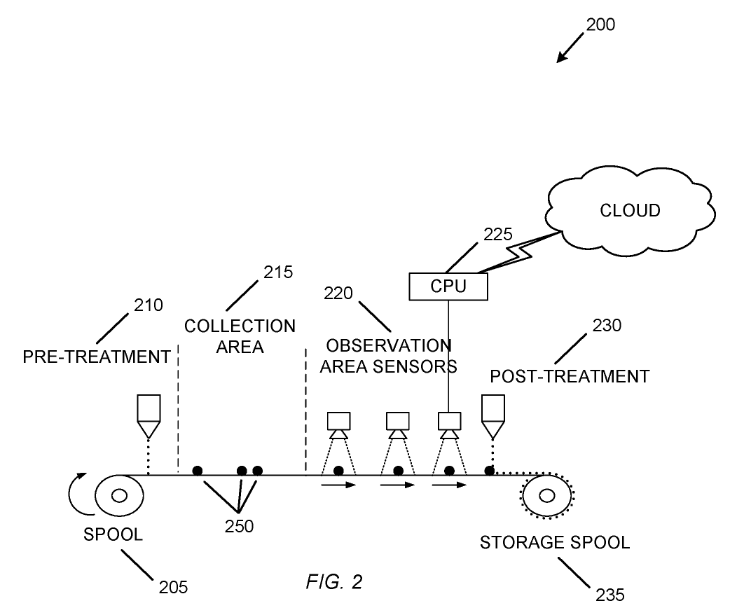

FIG. 2 illustrates a system and a process 200 of ground truthing automated insect sensors in accordance with certain embodiments. In some embodiments, a capture surface (e.g., sticky paper) can be continuously fed or be incremented at set intervals allowing for identification of insects captured at certain portions of the capture surface to correspond to certain time intervals.

As shown in FIG. 2, at 205, an insect capture device such as insect capture device 105 from FIG. 1 can include a spool of substrate material. The substrate material can have an upper surface and a lower surface where the upper surface is dispensed onto a surface (e.g., a flat surface). In some embodiments, the substrate material can be paper, plastic or other types of material. In certain embodiments, the substrate material can be a sticky paper, with adhesive already applied to one surface of the substrate material.

At 210, a pre-treatment can be performed on the spool of substrate material. In some embodiments, the pre-treatment may be an application of an adhesive to at least one of the upper or lower surfaces. In an example, a material with adhesive properties is applied to the upper surface. An example of the spool of substrate material after being applied with a pre-treatment coating of adhesive can be sticky paper. In some embodiments, the pre-treatment may be a dispensing of a type of preservative or reactant. For instance, the preservation material may have honey or other sugar solution added thereby enabling the capture of insect saliva. In certain embodiments, the trap can also include FTA paper or other material capable of preserving RNA/DNA.

A motor can be coupled to the substrate material and configured to rotate the roll of substrate material to dispense the substrate material. The substrate material can be dispensed into an insect trap where insects may get caught on the adhesive surface of the substrate material. In some embodiments, the insect trap may be a portion of the spool that is exposed to the environment and accessible to insects in the environment. As shown at 215, the insect trap may be located at the collection area. In some embodiments, the collection area can be in an enclosure where the portion of the spool that is capturing insects is laid out on a surface that is within the enclosure. In certain embodiments, the collection area can be an area that is out in the open where the portion of the spool that is capturing insects is laid out on a surface and exposed to the environment. As the spool of material passes through collection area 215, a portion is exposed to the environment, allowing insects 250 to be trapped by the spool of material. Certain embodiments may use a set of revolving vials or containers each designed to capture and hold a single or small number of insects instead of using sticky paper to capture insects.

Some embodiments may include a timestamp mechanism that permits the later identification of a time at which an insect is captured by the insect trap. In certain embodiments, different portions of the spool of substrate material may be exposed to the environment at different periods of time. For instance, the portion of the substrate material at 5-10 feet from the beginning of the spool may be exposed for trapping insects at 9-10 am. A computing device may keep track of the portions of the spool that correspond to different time periods. In some examples, visible marks may be made on the substrate to delineate time periods. Such marks may be made in real-time, such as with a stamp or marker, or may be prefabricated on the substrate. In certain embodiments, when the captured data is sent to a service for classification, the computing device may map the portions of the spool to their corresponding time periods and transmit the time at which each insect is captured to the service.

In some embodiments, the roll of substrate material may be rotated at a constant rate or at a variable rate. In areas where distribution of the insect is sparse, the roll of substrate may be rotated when the trap detects that something has come through the trap. The device may record the amount of time that the rotating has stopped and the amount of time that the roll has rotated to keep track of the time at which the insects are captured. Adjusting the rolling rate of the substrate material as needed may reduce the amount of substrate material that would need to be used for capturing. In addition to saving a large amount of substrate material, the time needed for the person to review the roll of substrate material may also be reduced. Further, by saving the amount of substrate material that would be dispensed for capturing, the roll of substrate material may be used for a longer period of time.

Certain embodiments can include one or more observation area sensors 220 that can capture information about each of the captured insects. The sensors can include one or more of a variety of different types of sensors, such as image sensors, heat sensors, sound sensors, odor sensors (e.g., an electronic nose), weight sensors, size sensors, electric conductivity sensors, etc. The image sensor can capture images or video. Some embodiments may funnel images to a remote service to enable visual identification even without machine learning algorithms, for example, by using expert or amateur human assessment, or a mix of human and machine classification. One or more computing devices (including one or more processors), such as that shown at 225, can be coupled to the one or more sensors. An example of a computing device can be shown in FIG. 5. The one or more computing devices (or processors) can communicate with one or more other computing devices (e.g., via a network) to transmit the captured information pertaining to the captured insects.

Some embodiments include a post-treatment area 230 that can treat the captured insects after information has been captured by the various sensors. Certain embodiments may dispense a protective covering (e.g., a secondary film seal) over the substrate to encase the captured insects, for example for later study. The protective covering may be a wax paper, an epoxy layer, a plastic sheet, etc. Certain embodiments can store the post-treated substrate by rolling the post-treated substrate into a spool, such as that shown at 235.

Certain embodiments may use a roll of sticky paper as sticky paper is more convenient and scalable. While vials may also be used and may be moved in a rotating manner through a trap enclosure to capture insects, vials may run out more quickly at locations where there is a high insect capture rate. To accommodate a higher capture rate for a longer period of time, a larger roll of sticky paper, or multiple rolls, may be used. Further, using sticky paper to capture the insects permits larger portions of the insects to be kept intact compared to using other insect traps such as vials as insects may often dry out and fall apart when captured by vials.

Further, some embodiments may custom print information such as information that might be interesting or important onto the substrate. For instance, the system may print information such as denoting a field trial for a capture period on the sticky paper so that a person may later be reminded of this information when reviewing the captured results. The person would know that the captured insects at this portion of the roll may correspond to released insects instead of wild insects. In another instance, the system may print information such as the time at which the sticky paper is exposed to the environment to capture insects so that the person may later be reminded that the captured insects at this portion of the roll may correspond to a certain time period. Such information may be printed as human-readable text or may be machine readable encodings, such as bar codes, QR codes, or machine readable glyphs.

In addition to custom printing, some embodiments may encode information onto paper in different ways, such as via a mechanical form. For instance, some embodiments may make physical changes to the substrate material such as by punching holes on to the sticky paper or by adding a magnetic strip to portions of the substrate material.

Some embodiments can spray certain chemicals onto the substrate that may react with substances (or other chemicals) on the insects. For instance, the system may pre-treat the sticky paper in a way that reacts with certain substances on the insects (e.g., substances that are a part of the insect's chemical makeup, chemicals dusted onto mosquitoes for trials on capturing released mosquitoes, etc.). Suitable pre-treatment substances that can be deposited onto the substrate include litmus or other types of reacting substances. The pre-treated sticky paper may change color as a way to more easily distinguish the wild mosquitoes from a recaptured released mosquito. In some embodiments, the pre-treatment substance may aid in the preservation of the specimen. For instance, the pre-treatment substance may include preserving chemicals (e.g., FTA) that can help preserve the DNA or RNA of the insects. In the instance of a vial as the insect capturing means, the interior of the vial may be coated with a preservative.

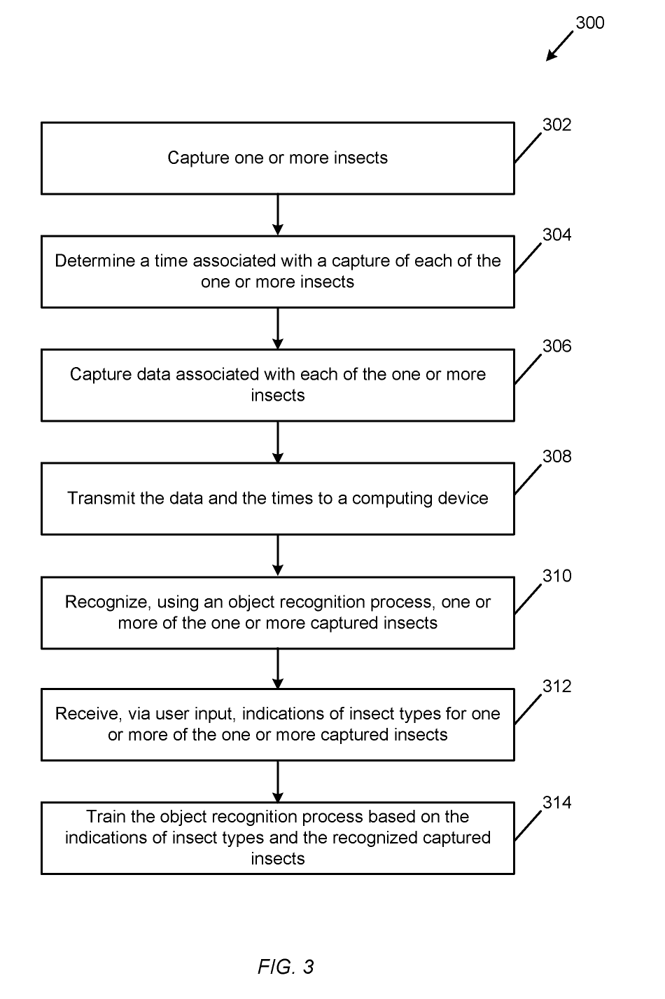

FIG. 3 depicts a flow chart for ground truthing automated insect sensors in accordance with certain embodiments. Some embodiments can train an object recognition algorithm for classifying insects. Certain embodiments may capture insects and use an expert (e.g., a person skilled in classifying insects) or a combination or human and machine recognition to classify the insect. The object recognition algorithm may then be trained based on the classification information from the expert or the combination of human and machine recognition.

At block 302, process 300 can capture one or more insects. Some embodiments may use a specialized trap with a rolling piece of sticky paper to capture insects. In some embodiments, the trap may have a revolving set of vials or containers that can capture and hold a single or small number of insects. Certain embodiments may use a trap enclosure that has a trap volume and at least one opening where insects can enter the trap volume from an environment. Some embodiments can use a specialized trap where the trap can take a set of images of each insect as the insect flies into the trap.

At block 304, process 300 can determine a time associated with a capture of each of the one or more insects. In certain embodiments, the rolling piece of sticky paper can have a timestamp mechanism that enables the identification of the time at which the insect is trapped by the sticky paper. In one example, one or more processors can record a start time at which the sticky paper begins dispensing into the insect trap and the dispensing rate. The time at which an insect is trapped by the sticky paper may then be determined based on its location on the sticky paper from when the paper began dispensing and the dispensing rate (e.g., 1 m/min, 10 m/min, 10 cm/s). In another example, the timestamp mechanism may include an automated sensor that records the time at which an insect is captured. The position of an insect on the paper can correspond to a time of capture recorded by the automated sensor.

In some embodiments, the time of capture can be used as another data point in identifying the type of insect. Circadian rhythms show that different types of insects (or different species of mosquitoes) may be active at different times of the day, so the time itself can be used for identification for example by the object recognition algorithm. Some embodiments may also send the time data as part of the captured data to the remote service to aid the entomologist's assessment and classification of the insect.

At block 306, process 300 can capture data associated with each of the one or more insects. Some embodiments can use one or more sensors to capture the data. In certain embodiments, the one or more sensors can be positioned adjacent to the insect trap and capture information about the insects that enter the trap from the environment. Some embodiments may use a variety of types of sensors to capture the data, such as an image sensor, a light sensor, a sound sensor, etc.

At block 308, process 300 can transmit the data and the times to a computing device. The sensor signals including the captured information from the one or more sensors may be transmitted to a classification service (e.g., classification service 110 from FIG. 1) that can include one or more computing devices. In some embodiments, the classification service may include a local device coupled to the insect trap. The computing device may present the captured information to an expert via a user interface. The expert may classify each of the insects using the captured information. The time information enables the computing device to identify the time at which each insect is captured.

In some embodiments, the classification service can include one or more remote devices that can receive the captured information and present the captured information to one or more experts (e.g., entomologists) via a user interface of the remote device. The experts may then classify the insects based on the captured information.

At block 310, process 300 can recognize, using an object recognition process (e.g., an object recognition algorithm), one or more of the one or more captured insects. Some embodiments may perform an object recognition on the captured insects using the captured information and an object recognition algorithm. In some embodiments, the one or more processors performing the object recognition process may be coupled to the insect trap and the one or more sensors. As mentioned above, the object recognition process may identify the insect using a variety of factors, including a time at which the insect was captured.

At block 312, process 300 can receive, via user input, indications of insect types for one or more of the one or more captured insects. In some embodiments, responsive to transmitting the data and the times to a computing device for classification information, the one or more processors coupled to the insect trap and the one or more sensors can receive indications of insect types for one or more of the one or more captured insects. As mentioned above, the indications of insect types (also referred to as classification information) can be specified by one or more experts in insect classification.

Some embodiments may pre-identify insects such that the captured data may be sent to certain entomologists versus others. As some insects may have a large number of species, not all entomologists may be able to distinguish all the different species from each other. Some entomologists may be more familiar with certain types of species. As such, certain embodiments may use the object recognition process to help perform a pre-identification using the captured data and calculate a confidence level for different species to which an insect may correspond. Upon determining the confidence level, the insect recognition system may determine (e.g., via a database that includes information on different entomologists and their specialties) a set of entomologists to send the captured data for insect classification.

At block 314, process 300 can train the object recognition process based on the indications of insect types and the recognized captured insects. Upon receiving the indication of insect types for one or more of the one or more captured insects, some embodiments may use the indications to ground truth the object recognition process (or the sensors coupled the processors performing the object recognition algorithm).

Some embodiments may also preserve the captured insects as specimens. In certain embodiments, the trap may contain preservatives to ensure that the insect samples are suitable for further analysis when collected.

Further, some embodiments may use multiple vials, discs, flip cards or other types of surfaces or containers, instead of moving sticky paper, to capture the insects. So long as there is a time varying portion of the surfaces or containers that is exposed where the insect may be captured, the system may be able to capture the insects and later identify the individual insects to a particular time or time interval to which they were captured.

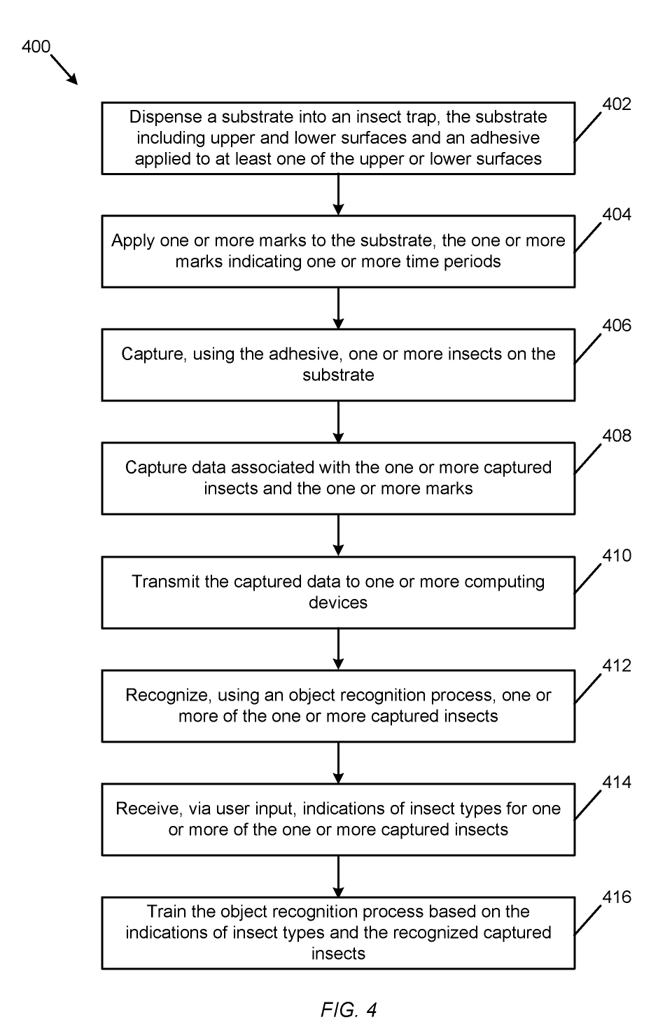

FIG. 4 depicts another flow chart for ground truthing automated insect sensors in accordance with certain embodiments. Certain embodiments may train an object recognition algorithm coupled to one or more sensors such that the insect trap can automatically identify the species of an insect (e.g., mosquito) as the insect flies through the trap. Instead of capturing the insects, some embodiments may perform instantaneous data capture and train the object recognition algorithm using the captured data on the insects as the insects fly by a certain area.

At block 402, process 400 can dispense a substrate into an insect trap, the substrate including upper and lower surfaces and an adhesive applied to at least one of the upper or lower surfaces. By using a sticky rotating roll of paper, insects flying into the trap may become stuck on different parts of the sticky paper as the sticky paper rolls.

At block 404, process 400 can apply one or more marks to the substrate, the one or more marks indicating one or more time periods. Some embodiments can include a timestamp mechanism that can be positioned proximate to a roll of substrate material and apply (e.g., periodically) a mark to the dispensed substrate material.

At block 406, process 400 can capture, using the adhesive, one or more insects on the substrate. Certain embodiments may capture the insects in a way that can be analyzed later.

At block 408, process 400 can capture data associated with the one or more captured insects and the one or more marks. Some embodiments can determine a time or a time interval at which one or more insects were captured using the one or more marks. In certain embodiments, the marks may be done physically on the substrate material such that the marks may be captured upon visual inspection. In some embodiments, the marks may be done virtually such that the marks may be captured by computing, using a computing device, a time elapsed since the start time at which the substrate started dispensing and a dispense rate.

Some embodiments may capture images under different lighting conditions. The images may be collected and processed in the device and the sent remotely for processing separately in certain embodiments. Certain embodiments may collect information such as images from different angles, the conductivity or electrostatic response to electrical stimulus, sound response to acoustic stimulus, responses to different wavelengths or to different thermal stimulus, the smell from different olfactory stimulus, the mechanical motions of the insects in response to stimulus such as a puff of air, vibration, or shaking of a surface on which the insects are located, a genetic analysis on the insect. Different species may respond characteristically differently to different types of stimulus. Some embodiments may feed the various responses of the different species into the machine learning object recognition system and improve the classification accuracy.

At block 410, process 400 can transmit the captured data to one or more computing devices (e.g., that are part of classification service 110 from FIG. 1). Some embodiments may deliver the information in real time or store the information up to a certain amount before the information is delivered.

At block 412, process 400 can recognize, using an object recognition process, one or more of the one or more captured insects. At block 414, process 400 can receive, via user input, indications of insect types for one or more of the one or more captured insects. At block 416, process 400 can train the object recognition process based on the indications of insect types and the recognized captured insects.

Using a variety of sensors to gather data on insects may help train the object recognition algorithm coupled to the sensors. Upon identifying the type of information that is needed to accurately classify insects using the object recognition algorithm, the sensors needed to be placed on a trap that can be widely distributed as a go-to-market trap (or the minimum complement of sensors needed to obtain good efficacy in a cost-effective manner) may be identified and prioritized.

In addition to using the captured data to train the object recognition algorithm for identifying species, some embodiments may use the captured data to train other types of classifications. For instance, certain embodiments may train the object recognition algorithm coupled to the sensors for gender, for whether the female insects are egg-bearing, or for identifying those insects carrying certain viruses (e.g., whether a mosquito is carrying certain viruses such as the Zika Virus, West Nile Virus, etc.).

FIG. 5 shows a block diagram of a computer system 500 according to certain embodiments. Computer system 500 can serve as the CPU 225 in FIG. 2. Computer system 500 can be implemented as any of various computing devices, including, e.g., a desktop computer, a laptop computer, a tablet computer, a phone, a PDA, or any other type of electronic or computing device, not limited to any particular form factor. Such a computer system can include various types of computer readable media and interfaces for various other types of computer readable media. Examples of subsystems or components of computer system 500 are shown in FIG. 5. The subsystems shown in FIG. 5 are interconnected via a system bus 505. Additional subsystems such as a storage subsystem 510, processing unit(s) 515, user output device(s) 525, user input device(s) 520, and network interface 530, and others are shown.

Processing unit(s) 515 can include a single processor, which can have one or more cores, or multiple processors. In some embodiments, processing unit(s) 515 can include a general-purpose primary processor as well as one or more special-purpose co-processors such as graphics processors, digital signal processors, or the like. In some embodiments, some or all processing unit(s) 515 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 515 can retrieve and execute instructions stored in storage subsystem 510.

Storage subsystem 510 can include various memory units such as a system memory, a read-only memory (ROM), and a permanent storage device. The ROM can store static data and instructions that are needed by processing unit(s) 515 and other modules of computer system 500. The permanent storage device can be a read-and-write memory device. This permanent storage device can be a non-volatile memory unit that stores instructions and data even when computer system 500 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 510 can include any combination of computer readable storage media including semiconductor memory chips of various types (DRAM, SRAM, SDRAM, flash memory, programmable read-only memory) and can include removable storage media that can be readable and/or writeable; examples of such media include compact disc (CD), read-only digital versatile disc (e.g., DVD-ROM, dual-layer DVD-ROM), read-only and recordable Blue-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 510 can store one or more software programs to be executed by processing unit(s) 515, such as an application (not shown here). As mentioned, “software” can refer to sequences of instructions that, when executed by processing unit(s) 515 cause computer system 500 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 510, processing unit(s) 515 can retrieve program instructions to execute and data to process in order to execute various operations described herein.

A user interface can be provided by one or more user input devices 525 and user output devices 520 such as a display. Input devices 525 can include any device via which a user can provide signals to computing system 500; computing system 500 can interpret the signals as indicative of particular user requests or information. In various embodiments, input devices 525 can include any or all of a keyboard touch pad, touch screen, mouse or other pointing device, scroll wheel, click wheel, dial, button, switch, keypad, microphone, and so on.

User output devices 520 can include a display that displays images generated by computing device 500 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of a display. Examples include indicator lights, speakers, tactile “display” devices, printers, and so on.

In some embodiments, user output devices 520 can provide a graphical user interface, in which visible image elements in certain areas of user output devices 520 such as a display are defined as active elements or control elements that the user selects using user input devices 525. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in the display. Other user interfaces can also be implemented.

Network interface 530 can provide voice and/or data communication capability for computer system 500. In some embodiments, network interface 530 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 530 can provide wired network connectivity (e.g., Ethernet) in addition to or instead of a wireless interface. Network interface 530 can be implemented using a combination of hardware (e.g., antennas, modulators/demodulators, encoders/decoders, and other analog and/or digital signal processing circuits) and software components.

Bus 505 can include various system, peripheral, and chipset buses that communicatively connect the numerous internal devices of computer system 500. For example, bus 505 can communicatively couple processing unit(s) 515 with storage subsystem 510. Bus 505 also connects to input devices 525 and user output devices 520. Bus 505 also couples computer system 500 to a network through network interface 530. In this manner, computer system 500 can be a part of a network of multiple computer systems (e.g., a local area network (LAN), a wide area network (WAN), an Intranet, or a network of networks, such as the Internet. Any or all components of computer system 500 can be used in conjunction with the invention.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 515 can provide various functionality for computer system 500. For example, processing unit(s) 515 can execute an application that can provide various functionality such as the ability to recognize insects, the ability to ground truth an insect recognition system, the ability to present information on a captured insect (e.g., images of a captured insect from different angles, DNA information on a captured insect), ability to present options to a human to allow the human to select an option corresponding to an insect species, etc.

It will be appreciated that computer system 500 is illustrative and that variations and modifications are possible. Computer system 500 can have other capabilities not specifically described here (e.g., global positioning system (GPS), power management, one or more cameras, various connection ports for connecting external devices or accessories, etc.). Further, while computer system 500 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including X, Y, and/or Z.

What is claimed is:

1. An apparatus for ground truthing an insect recognition system, the apparatus comprising:
a roll of substrate material, the substrate material having upper and lower surfaces and an adhesive applied to at least one of the upper or lower surfaces;
a motor coupled to the roll of substrate material and configured to rotate the roll of substrate material to dispense the substrate material into an insect trap;
a sensor positioned along a dispensing path of the substrate material and configured to capture information associated with the surface of the dispensed substrate having the adhesive, the sensor further configured to output sensor signals based on the captured information; and
a computing device including one or more processors, the computing device configured to receive the sensor signals from the sensor, to transmit at least a portion of the captured information to a remote computing device, to receive classifications of insects based on the captured information from the remote computing device, and to train a machine-learning insect classifier based on the classifications.

2. The apparatus of claim 1, the apparatus further comprising:
a timestamp mechanism positioned proximate to the roll of substrate material and configured to periodically apply a mark to the dispensed substrate material, wherein the sensor is further configured to capture information associated with the marks.

3. The apparatus of claim 1, wherein the computing device is further configured to determine a time associated with an insect based on a movement rate of the roll of substrate material and elapsed time from an initial time when the roll of substrate material began dispensing.

4. The apparatus of claim 1, further comprising:
a coating dispenser comprising a coating container and a coating dispensing vessel, a first end of the coating dispensing vessel coupled to an orifice in the coating container and a second end of the coating dispensing vessel movable to be proximate to an adhesive surface of the substrate material to dispense a coating from the coating dispensing vessel at the adhesive surface of the substrate material.

5. The apparatus of claim 4, wherein the coating is a preservative for preserving at least a portion of one or more insects that land on the insect trap.

6. The apparatus of claim 1, wherein the one or more sensors includes at least one of an image sensor or a microphone.

7. The apparatus of claim 1, wherein the computing device is further configured to classify, using the insect classifier, one or more insects based on the captured information, and wherein the machine-learning insect classifier is trained further based on the classified one or more insects.

8. A method for ground truthing an insect recognition system, comprising:
dispensing a substrate into an insect trap, the substrate comprising upper and lower surfaces and an adhesive applied to at least one of the upper or lower surfaces;
periodically applying marks to the substrate as it is dispensed, the marks indicating time periods;
capturing, using the adhesive, one or more insects on the substrate;
capturing data associated with the one or more captured insects and the marks;
transmitting the captured data to a computing device;
recognizing, using an object recognition process, one or more of the one or more captured insects;
receiving, via user input, indications of insect types for one or more of the one or more captured insects; and
training the object recognition process based on the indications of insect types and the recognized captured insects.

9. The method of claim 8, wherein the captured data includes at least one or more of image data or sound data.

10. The method of claim 8, wherein the one or more insects are identified by an entomologist using the captured data at the computing device.

11. A method for ground truthing an insect recognition system, comprising:
capturing one or more insects;
capturing a time associated with a capture of each of the one or more insects;
capturing data associated with each of the one or more insects;
transmitting the data and the times to a computing device;
recognizing, using an object recognition process, one or more of the one or more captured insects;
receiving, via user input, indications of insect types for one or more of the one or more captured insects; and
training the object recognition process based on the indications of insect types and the recognized captured insects.

12. The method of claim 11, wherein training the object recognition process includes:
comparing the recognized one or more of the one or more captured insects against the received indications of insect types for one or more of the one or more captured insects; and
adjusting the object recognition process based on the comparison.

13. The method of claim 12, further comprising:
analyzing the insect data using the insect recognition algorithm; and
determining, based on the analysis, one or more insects and a confidence level associated with each of the one or more insects,
wherein sending the insect data includes providing the one or more determined insects and the confidence level associated with each of the one or more insects to an entomologist via a user interface associated with the computing device.

14. An apparatus for ground truthing an insect recognition system, the apparatus comprising:
an insect trap enclosure defining a trap volume and having at least one opening to enable insects to enter the trap volume from an environment;
a sensor positioned proximate to the insect trap configured to capture information about insects that enter the trap volume from the environment and to transmit sensor signals comprising the captured information;
a computing device in communication with the sensor and configured to:
receive the sensor signals;
recognize, using an object recognition process, at least one insect based on the captured information;
receive an indication of a type of insect based on the displayed captured information; and
train the object recognition process based on the recognized insect and the indication of the type of insect.

15. The apparatus of claim 14, further comprising:
a roll of substrate material, the substrate material having upper and lower surfaces and an adhesive applied to at least one of the upper or lower surfaces;
a motor coupled to the roll of substrate material and configured to rotate the roll of substrate material to dispense the substrate material into the trap volume;
a timestamp mechanism positioned proximate to the roll of substrate material and configured to periodically apply a mark to the dispensed substrate material; and
wherein the sensor is positioned along a dispensing path of the substrate material and configured to capture information associated with (i) the surface of the dispensed substrate having the adhesive and (ii) the marks.

16. The apparatus of claim 14, further comprising:
a plurality of vessels disposed within the trap volume, each of the vessels having an insect attractant substance within the vessel,
and wherein the sensor is positioned proximate to at least one of the vessels and configured to capture information about one or more insects captured within the at least one vessel.

17. The apparatus of claim 14, wherein the sensor comprises a camera and the captured information comprises one or more of an image or a video.
